(19) United States
(12) Patent Application Publication
(10) Pub. No.: US 2014/0361453 A1
(43) Pub. Date: Dec. 11, 2014

(54) Method and apparatus for appreciating artwork

(71) Applicant: Vaios Triantafyllou, Boston, MA (US)

(72) Inventor: Vaios Triantafyllou, Boston, MA (US)

(21) Appl. No.: 13/998,110

(22) Filed: Oct. 1, 2013

Related U.S. Application Data
(60) Provisional application No. 61/956,527, filed on Jun. 10, 2013.

(51) Int. Cl. B29C 67/00

(52) U.S. Cl. CPC B29C 67/0088; B29L 2031/722
USPC 264/40.1; 425/375; 425/135

(57) ABSTRACT

A system is provided for a blind person to provide the person with the experience of seeing a two dimensional piece of art by scanning the two dimensional piece of art, extracting various features and creating a three dimensional rendition of the two dimensional art using the extracted features.

### RELATED CASES

This application claims rights under 35 USC §119(e) from U.S. Application Ser. No. 61/956,527 filed Jun. 10, 2013, the contents of which are incorporated herein by reference.

### FIELD OF THE INVENTION

This invention relates to creating 3-dimensional artwork from 2-dimensional artwork and more particularly to a system for providing individuals with a new way for experiencing 2-dimensional artwork.

### BACKGROUND OF THE INVENTION

As will be appreciated paintings are created on 2-dimensional surfaces which cannot be viewed by blind individuals, with the artwork having to be described to the individual verbally in order to provide the individual with an appreciation of the artwork. This handicap is particularly severe for semi-sighted individuals who may have been able to experience the world through sight but who now have very little ability to appreciate 2-dimensional artwork.

Moreover, when viewing a painting that which is appreciable is that which is on the 2-dimensional surface. It is impossible for instance to enhance this 2-dimensional viewing experience presently except for either magnifying the artwork or providing a different lighting on the artwork so that various features of the artwork can be appreciated.

There is therefore a need to be able to allow the appreciation of 2-dimensional artwork in ways that are not heretofore possible so as to either increase the viewing experience or to in fact make the experience visible in some manner to sightless individuals.

Also, with respect to large sculptures and monuments is oftentimes impossible for an individual to view the large sculpture in its entirety for instance by standing in front of the sculpture or monument and it would be useful to be able to provide a 3-dimensional rendition of the sculpture or monument in a small enough scale so that an individual viewing the smaller form can appreciate the entire sculpture or monument without having to piece it together mentally from viewing portions of the sculpture or monument.

More particularly, it will be appreciated that the vast majority of paintings are representations of a 3-dimensional world. Colors, or a combination of colors as opposed to just a black and white renditions, are essential for the creation of a painting. Note that coloring is not merely a stylistic aspect of a painting. Rather it is primarily used for making each object distinguishable from the rest of the objects in the painting. Not only is color important to be able to distinguish various objects in a painting, shading is also utilized which helps in depicting the essence of a 2-dimensional piece of art.

As will be appreciated, painters use disparities in the size of different objects to denote distance and closeness between items. Therefore artists can represent a 3-dimensional world on a 2-dimensional surface through different colors and sizes as well as lines and shades.

It will be appreciated that looking at a painting is mainly a passive process since individuals use the sense of sight to perceive the subject matter of the painting. As will be appreciated individuals viewing a painting only interact with the painting mentally and not physically due to the fact that it is presented in 2-dimensions. Given only one sense, namely sight, there is a requirement for one to understand the orientation of objects around the individuals. Thus it can be concluded that it is relatively hard to grasp a good understanding of a painting's perspective based solely on a 2-dimensional representation.

Taking the mental composite out of the picture, it is obvious that the way objects are placed in a painting with respect to one another make it impossible for a sightless person to appreciate the artwork.

With respect to large sculptures and monuments, the size of the sculptures and monuments makes it hard for an individual to grasp the entire artwork, based on the massive size itself. Although the sculptures and monuments are built in 3-dimensions, individuals essentially use their sight to understand the structure. In order to do this, the individual must break up the structure into those which are easily ascertainable in the individual's line of sight, leaving the other parts of the structure unanalyzed when the individual is looking straight at these particular structures. Moreover, merely touching a large structure or a monument does not provide a great deal of information given the relatively small stature of human beings as opposed to the sculptures and monuments they are seeking to understand.

Furthermore, it is sometimes useful for individuals to hear a description of a painting and the techniques used. This verbal rendition of the subject matter of the painting and the way it was created is useful to engage the individual looking at the painting to be sensitive to the processes and parts of the painting or artwork that appear to have a particular relevance. However, the mere verbal description of a painting, the history of its creation and the various aspects of the painting that a presenter presumes to be relevant are very difficult for a sightless person to understand.

In short, it would be useful to be able to take a 2-dimensional artwork or even a large scale 3-dimensional artwork and convert it into a 3-dimensional model having certain characteristics which emphasize the features of the artwork so that sightless individuals can feel the image and therefore understand the artwork and so that sighted individuals can have a different experience of a 2-dimensional artwork when transformed into a 3-dimensional artwork.

As to the blind who are not able to see a painting, for instance, it would be useful to be able for the blind person to be able to touch and hear a representation of the 2-dimensional artwork in order to grasp an understanding of what the artist depicts in his 2-dimensional rendition. Moreover, as far as children are concerned, children would find it easier to understand a painting by touch as opposed to sight in some instances, with the children more engaged and fascinated by hearing and touching a 3-dimensional object that corresponds to the 2-dimensional object which they are seeking to understand.

### SUMMARY OF THE INVENTION

In order to assist the blind to be able to experience artwork in the form of a painting which is a 2 dimensional piece, the artwork is scanned by a features extraction detector which is then coupled to a 3D printer for printing a 3D representation of the 2 dimensional artwork with the features being converted into 3 dimensional features of the 3D printed rendition. This permits an individual seeking the ability to experience the artwork by touching the 3D printed rendition. Strictly speaking what is presented is a three dimensional representation on a flat plane. When used herein, 3D refers to the three dimensional rendering of the 2D artwork.

In one embodiment, the 3D printed rendition may be provided with a textured surface in which the texture corresponds to the paint or ink composition used in the original artwork. One of the features that can be extracted from the original artwork are the contours between light and dark areas of the original artwork or for instance between different colors or shades.

Additionally, a further way to experience the original artwork is to provide a proximity detection system for measuring the proximity of one's finger to the surface of the 3D rendered artwork. Proximity may be indicated by an audio queue such that by moving one's finger over the artwork one can “understand” the artwork in terms of the audio tones or queues used during the sweep of one's hand.

While the subject invention has particular applications to sightless individuals, the system may be utilized as an enhanced appreciation mode for individuals having all of their senses intact.

More particularly with respect to original works of art and the artists themselves, in the subject invention one provides a multi-dimensional representation of the art preferably in a 3-D format so that sightless individuals can experience the 2-D art by touching the 3-D representation of the art. It is thus the purpose of the subject invention to give a new perspective to already existing 2D artwork but to do so in 3 dimensions.

In order to accomplish this in one embodiment a computer aided design rendering of each painting is generated. What is done is to for the person creating the 3-dimensional rendition to represent all the contours of all the objects in the painting which are identified and then inputted into computer software. The contours are then extruded to 3-dimensions thus creating the 3-dimensional model corresponding to each painting.

As far as sculptures and monuments is concerned one does a rendering of each side of the monument or the sculpture and then combines the result in CAD models to reproduce the original, but on a smaller scale.

The CAD model may utilize either 3-D printing technology or CNC milling technologies, with the result being the transformation of the 2-dimensional artwork into a 3-dimensional rendering, with emphasis on the ability to extract from the 2-dimensional artwork contours and other features which when rendered 3-dimensionally provide a different type of experience of the artwork. The result of the 3-dimensional printing is that for instance different types of plastic for different aspects of the painting may be used so that blind people are able to distinguish between the objects due to feel. Also when creating the 3-dimensional printing part of the 3-dimensional printing texture may be used that has the same texture or feel as the particular paint within the particular contour so that sightless people can get a feeling of what the paints feel like. This is because color does not make sense to a sightless individual, but rather texture does. Moreover, children would be fascinated to be able to see and feel the difference between the textures of the paint and learn how to distinguish between different textures and paints.

As a substitute for tactile feedback to be able to appreciate a 2-dimensional piece of art in 3-dimensions, it is possible to activate a verbal description of the portion of the artwork touched either by tactile sensing or non-tactile proximity sensing such that when a person's finger is adjacent an artwork feature an audio description of that feature may be given to the individual.

Presently there are various proximity sensors such as ultrasound sensing, infrared radiation and therescopic sensing cameras.

Aside from making a 2-dimensional piece of artwork accessible to blind individuals, the subject system involves characterizing the 2-dimensional artwork in 3-dimensions to make perspective and depth of field more easily understood, especially since shades may be emphasized. Moreover, small details that would otherwise be underappreciated or unrecognized are highlighted when a 2-dimensional artwork is transformed into a 3-dimensional piece of artwork.

Also based on the initial piece of artwork there are infinite new 3-dimensional pieces of artwork that can be created, with each one for instance corresponding to a different angle from which the artwork is observed. Moreover, a process that is currently passive, namely the viewing of a 2-dimensional piece of art is transformed into an interactive one involving the 3-D rendering of the original artwork to give an enhanced experience to both sighted and hearing individuals as well as providing tactile functions to non-sighted individuals so that not only are blind people provided with a rich experience, sighted and hearing individuals may also experience artwork with a greater degree of understanding. As will be appreciated the more senses involved in understanding an artwork the more intense the experience becomes. With the subject system, the individuals feel like they have become part of the artwork itself. Note that the utilization of 3-D printing to provide the 3-dimensional artwork involves ground breaking technology that may now be used to experience 2-dimensional artwork.

In summary, a new way of experiencing 2-dimensional artwork is provided by converting 2-dimensional artwork into a 3-dimensional rendition with the features of the rendition being selectable by the individual or machine that scans the original 2-dimensional artwork, decides which contours are useful in describing areas that will be raised or lowered with respect to a 3-dimensional rendition and to provide a different feel of the painting through the creative energies of the individual who converts the scanned image into the 3-dimensional image, thus to provide not necessarily a slavish copy of the 2-dimensional image in 3-dimensions but rather one that involves artistry in selecting the particular inputs for the 3-dimensional printer that can emphasize or deemphasize objects within the painting or 2-dimensional artwork.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the scanning of a 2-dimensional piece of art followed by feature extraction and the utilization of a 3-D printer to provide a 3-dimensional rendition of the 2-dimensional picture;

FIG. 2 is a diagrammatic illustration of the feature extraction of FIG. 1 showing that the feature extraction results in extensions which are used to create a 3-D model that is in turn coupled to the 3-D printer;

FIG. 3 is a flow chart showing a process for converting a 2-dimensional piece of art into a 3-dimensional print showing the use of a 3-D modelling program using a command sketch tool, followed by feature outlining and the loading of lines into a 3-D modelling tool which lines are connected together to form areas that are then utilized through a boss height value to generate the 3-D print rendition;

FIG. 4 is a flow chart of a system for locally updating a 3-dimensional model involving a creation the list identifying all features related to a parent feature, followed by topology checks and spatial intercept checks, followed by the removal of faces of features in an identified list finally resulting in the regeneration of the features in the list;

FIG. 5 is a flow chart that embodies reusable data constructs from a modelling system suitable for the entry of extensions to create the 3-D model of FIG. 2; and,

FIG. 6 is a diagrammatic illustration of the provision of audio queues when an individual seeks to understand the 2-dimensional artwork by moving his or her hand over the 3-dimensional printed rendition of the 2-dimensional artwork.

### DETAILED DESCRIPTION

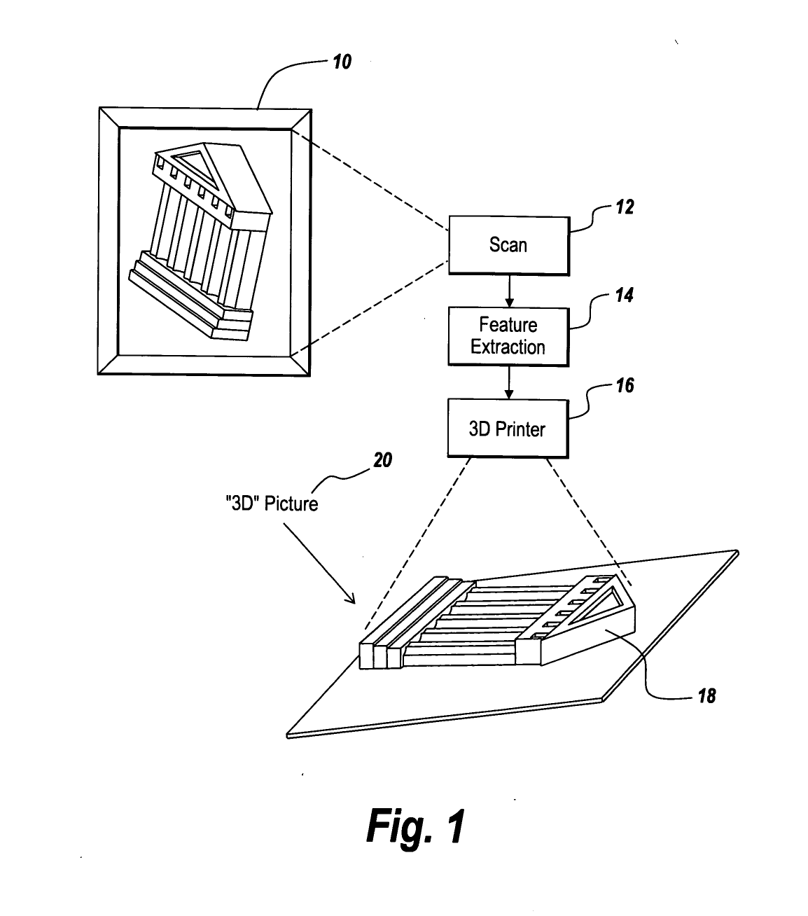

Referring to FIG. 1, an original 2D artwork 10 that deposits a portion of the Parthenon is scanned by a scanner 12, the output of which is coupled to a 3D printer 16. The 3D printer prints a 3 dimensional solid work rendition 18 of the original artwork by taking the extracted features of the original artwork and renders them in 3 dimensional solid work in a 3 dimensional printing process.

The result is a “3D picture” 20 whose surfaces can be felt by a blind person to give the blind person the experience of the 2 dimensional artwork which he or she cannot see. The blind person by running his or her hand over the solid work can get an idea of what the original 2D artwork represented. Moreover, even for sighted individuals the transformation of a 2D artwork into a 3D artwork utilizing the subject process can provide an enhanced appreciation of the artwork.

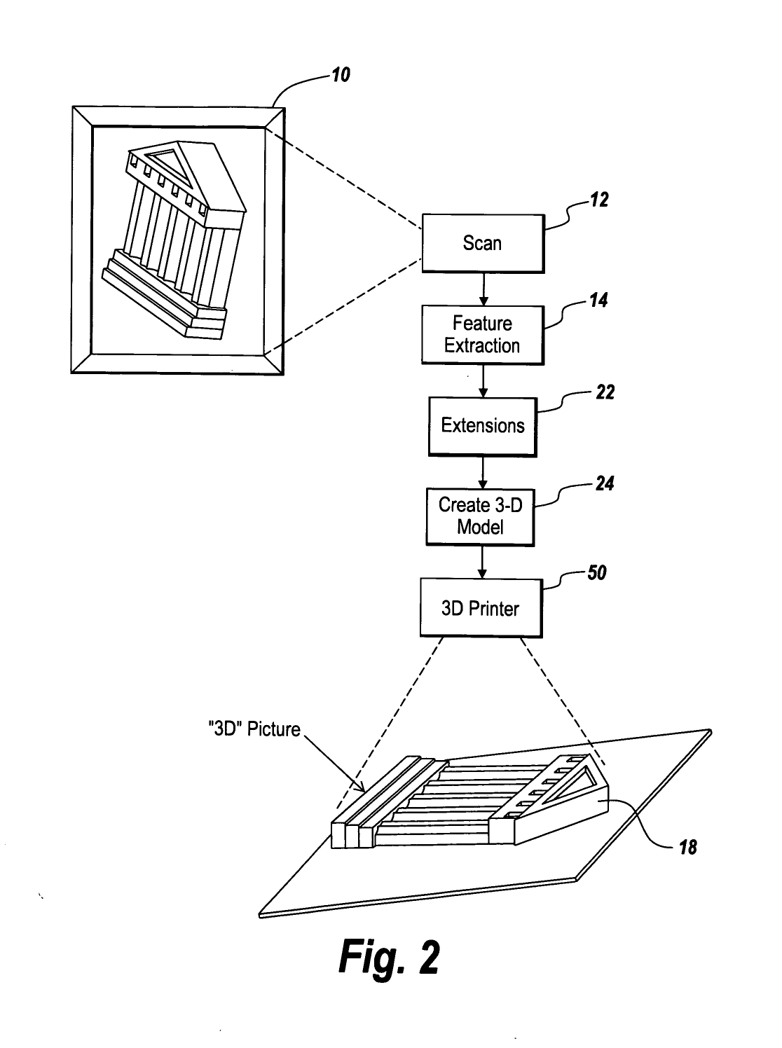

Referring now to FIG. 2, what is shown is feature extraction 14 that may be accompanied by the formation of extensions for use in a solid works 3D modelling program 24 the output of which is ported to 3D printer 16 in order to provide a “3D picture” 20. It will be appreciated that when a 3D picture is used in the subject context it means actually a 2-dimensional printer in which the back of the object is a flat plane and in which the raised portions create a 2.5-dimensional picture or a 3D picture without the back.

In order to transform a 2-dimensional image into a 3-dimensional object in one embodiment the first step is to download a picture from the World Wide Web. The image may be a painting which then has to be inserted into a solid works modelling program using a command sketch tool. It will be noted that the solid works program is a product by Dessault Systems Solid Works Corporation of Concord, Mass.

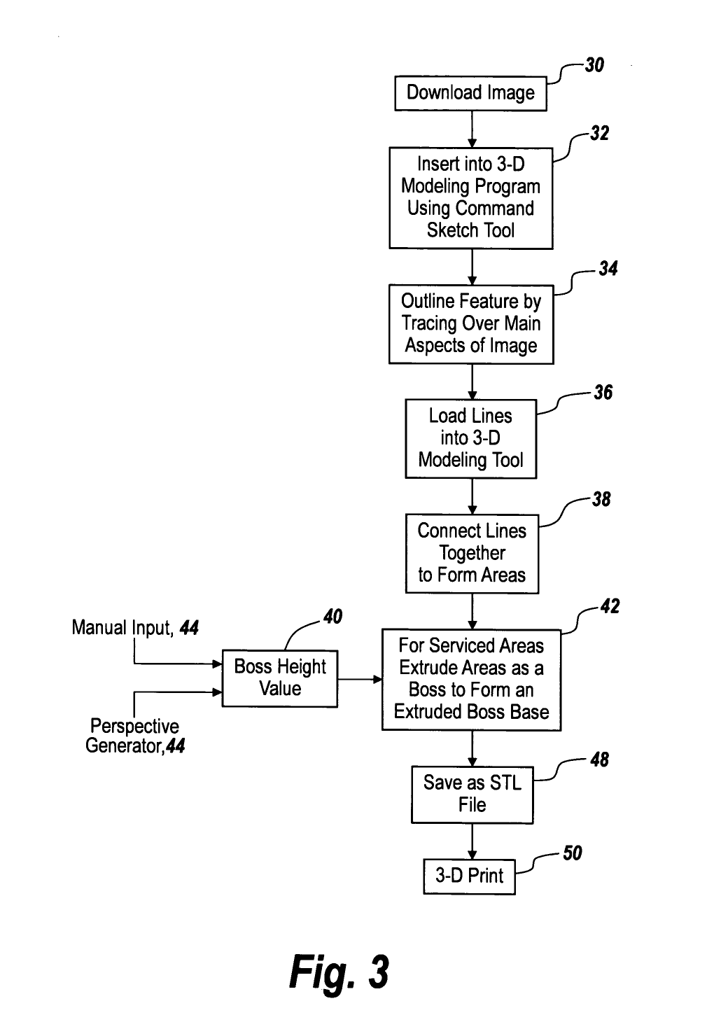

Referring to FIG. 3 the downloading of the image is shown at 30 in which the image is inserted into a 3D modelling program using the aforementioned command sketch tool as shown at 32. In the transformation process the individual creating the 3-dimensional image traces over the main aspects of the image, such as for instance hands, head or any predetermined image that the creator wishes. The trace of the image is in essence an outline of the feature as illustrated at 34 which is obtained by tracing over the main aspects of the image in the 2-dimensional artwork. As illustrated at 36 the trace lines are loaded into the 3-dimensional modelling tool with the ends of the lines being connected together to form areas as illustrated at 38.

As soon as the lines are connected with each other this defines areas circumscribed by the lines so that the individual creating the 3-D artwork can pick those areas and the amount they are to be extruded into 3-dimensions.

As illustrated at 40 the amount by which the areas are to be extruded corresponds to something called the boss height value since the areas within the joined together lines are extruded as a boss. Thus as illustrated at 42 for surface areas, the areas are extruded as a boss to form an extruded boss base with the base determining how far the area within the boss is to be extruded. As illustrated at 44 this may be a manual input by the creator of the 3-dimensional artwork or it can be generated automatically through a so-called perspective generator 46.

The boss height is determined by the creator of the 3-dimensional rendition such that if for instance the creator wishes to have the head be protruding further than the rest of the body or the hands, this means that the individual will command the 3-dimensional modelling tool to extrude the head more than for instance the hand.

This precedes for each of the features that are identified as being important to the 3-dimensional rendition of the 2-dimensional artwork such that for instance in a manual process one can select a person's head, his eyebrows, nose, mouth, chin and ears, all represented by the enclosed areas represented by the traced lines.

It is also possible to automatically specify boss height and this can be done using a program called matlab which basically uses a camera and scans the 2-dimensional artwork. One then programs the matlab to detect different pictures of the image or different sections of the image and instead of manually drawing lines, these areas are created automatically. This can be done by edge recognition and the like such that edges within the original 2-dimensional artwork are transformed into the aforementioned tracings that would have ordinarily been manually inserted into the solid works program. The matlab program can also be configured to choose the height with which to extrude the bosses.

The solid works 3-dimensional modelling tool also permits making identifications of some of the objects in the 2-dimensional artwork. For instance, if one wants to represent the head of an individual and it is originally in the shape of a rectangle, the solid works program permits changing the rectangle to any type of curve that one wishes, basically to configure the boss to look like a head. Thus, the selected features in the 2-dimensional artwork when extracted utilizing tracings and the like can be modified by the creator of the 3-dimensional artwork by modifying the object within the 3-dimensional modelling tool to make it look more like that which the creator thinks should be.

After the extruded boss base has been created, in one embodiment this is saved as an STL file 48 which is a type of file that is utilized in most 3-dimensional printers so as to be able to create the 3D rendition of the 2D artwork. This result of this printing is shown as a 3D print 50 which would be similar to that shown in FIG. 2 as the 3D “picture” 20.

In short, the 3D printer utilizes the STL file that has been created in the solid works modelling software and once the STL file has been loaded into the 3D printer, the 3D printer prints the 3D rendition of the 2-dimensional image with the particular heights specified as above. This then corresponds to a 3D model of the 2-dimensional artwork.

In short, in one embodiment of the subject invention one manually circumscribes or traces the outline of various areas in a 2-dimensional artwork and specifies the heights of the areas to be grown by the 3D printer, with the heights being manually inputted by the creator of the 3D artwork. Moreover, special effects can be achieved by for instance detecting different colors in the 2-dimensional artwork, with the different colors being extruded by a designated amount so that for instance colors could be detected by touching the 3-dimensional artwork.

Moreover, in the case of anatomical features of a human being or for instance features of a building or other structure, these types of features may be cataloged in a library such that the general shape of a head will be recognized when for instance a trace corresponds to that which would correspond to a head. Thus, by using a compendium of available figures for use in the 3-dimensional modelling, if a particular circumscribed area corresponds to a particular type of feature in the library the 3-dimensional modelling inputs can be varied so that what is presented in the 3-dimensional rendition of the 2-dimensional artwork corresponds for instance to a head, hand, eyebrow, facial feature or for instance a building block of a building or other edifice, should there be a strong correlation between the outlined feature and that which is available in the library.

In the preferred embodiment the library is build up manually as opposed to automatically so as to give the creator a certain amount of control over the process. As a result whatever shape is automatically inputted into the modelling tool, be it a building, text book, a shoe, or whatever, then if this shape corresponds to something in the library, the system can automatically convert that portion of the 2-D image to the 3-D rendition by first detecting edges, then making lines and then deciding what the area is within the lines and what it corresponds to in the library. The result is that the 3-dimensional modelling tool can take that outline and create the appropriate 3-dimensional boss.

For instance in the 3-dimensional rendering of an individual in a 2-dimensional artwork the subject program takes the image, takes the lines or edges, raises the areas within the lines or edges to show that it is within a particular plane and then renders the corresponding 3-dimensional boss to provide for the 3-dimensional depth of the 2-dimensional image. Thus, for instance if the individual is wearing a shirt, the shirt may be raised above that which would be the skin. If it happens to be the head, the head is raised from the background plane of the 2-dimensional artwork thus to give the 3-dimensional rendering a perspective that can be felt or touched, thereby to give the blind person an idea of what the 3-dimensional artwork is all about.

It will be noted that for a 2-dimensional piece of artwork perspective is not information in the set that is provided by simply viewing the artwork. However, an individual can recognize perspective in for instance a painting and take it into account as to how much to raise a particular area versus any other area in the 3-dimensional transformation of the 2-dimensional artwork.

What is therefore been provided is a way of transforming a 2-dimensional piece of art into a “3D picture” which is in essence a 2.5D picture with the back being flat and with features of the 3-dimensional picture rising from the back. The 3-dimensional picture that is extruded by the 3D printer carries with it the selected features and the enhancements of the features manually inputted to the system by an individual viewing the 2-dimensional artwork and deciding how that 2-dimensional artwork will be represented in 3-dimensions. As a result the creator of the 3-dimensional artwork has a great deal of control as to what features and textures will be presented in the 3-dimensional artwork, making the creator of the 3-dimensional artwork as much an author as the author of the 2-dimensional artwork from which it was transformed.

Thus, the 3-dimensional picture is not a slavish copy of the 2-dimensional artwork but rather is the incarnation of the artist who does the manual entering or in fact the creativity produced by a matlab program such that that which is felt by a blind person is a new type of experience for a 2-dimensional piece of art.

This having been said, it is important to note that the subject invention is not limited to the appreciation of 2-dimensional art by sightless individuals, but rather is a way of rendering 2-dimensional art in 3-dimensions so as to enhance the experience of the individual seeing and touching the 3-dimensional art. The type of transformation may not be a literal transformation but rather may be that created by the artist who incorporates the 2-dimensional features into the 3-dimensional modelling tool. The result can be striking in that what the creator of the 3-dimensional artwork intends may vary significantly from what one would apprehend in a 2-dimensional piece of art. This then extends the creativity of the artist to transform a 2-dimensional piece of art into a 3-dimensional piece of art by emphasizing or deemphasizing various features in the 2-dimensional piece of art that are to be transformed into raised portions or bosses in the final 3-dimensional rendition.

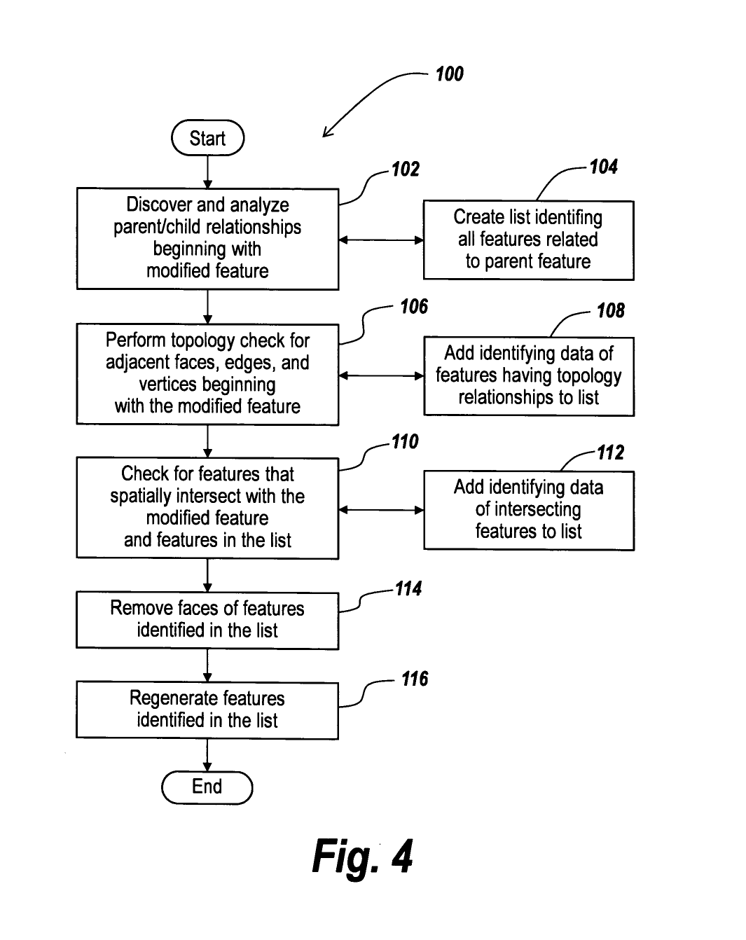

Referring now to FIG. 4, which is taken from U.S. Pat. No. 8,305,376 it is possible to alter the 3-dimensional artwork through the utilization of extensions. Thus, a 3-dimensional model may be updated by generating a 3-dimensional model comprised of components and modifying one of the components while at the same time determining other components having a possible changing effect on the 3-dimensional model as a result of modifying the one component. The solid works program then can construct a modified version of the 3-dimensional model by regenerating the modified component and the other components having the possible changing effect while not regenerating remaining ones of the components not having the possible changing effect. The modified version achieves the same result as revising the 3-dimensional model by regenerating each one of the components.

As discussed in the above-identified patent the flow diagram of FIG. 4 illustrates a process 100 in which the process identifies features that need to be updated due to a change in another feature that regenerates only those identified features as well as the modified feature. In the first step for instance parent/child relationships are discovered and analyzed beginning with the modified feature as shown at 102. In the illustrated embodiment the data structure of the modified feature is examined to determine whether the data structure contains pointers to one or more child features. If such pointers exist, a list is created and identified, and identifying data for each child feature is inserted into the list as illustrated at 104. The child features are also analyzed to discover whether other child features exist as illustrated at 102 and if so identifying data for the other descendant features, i.e. grandchildren of the modified feature, are inserted into list 104. Note, that the system performs a topology check for features that have adjacent faces, edges or vertices as illustrated at 106 with the topology check beginning with the modified feature. The data structure is searched and if a face, edge or vertex that was created by another feature is found, identifying data of the other feature that created the face, edge or vortex is added to the list as shown at 108.

As illustrated at 110 a process also checks whether features spatially intersect with one another. For any feature that spatially intersects with the modified feature or other features already identified in the list identifying data is added to the list shown at 112. In one embodiment a bounding box is created surrounding the modified feature. Then for each of the remainder features another bounding box is created. Identifying data is added to the list for each feature having a bounding box that intersects the bounding box of the modified feature. This method of checking for spatial overlaps using bounding boxes is then performed for each feature identified in the list. As additional features are identified in the list additional features are also checked for spatial overlap with other features.

Process 100 only makes incremental changes to the topology and geometry, while the topology and corresponding geometry of those features that are not regenerated are preserved. Thus the process removes the faces that were generated by the modified feature and the features in the list from the topological structure of the 3-dimensional model as shown at 114. Geometry associated with the faces may also be removed from the 3-dimensional structure. Faces may also be modified rather than removed. Additionally in some cases entities may need to be reconstructed or healed in order to maintain a valid model. In the next step of the process the features identified in the list are regenerated as illustrated at 116 whereupon the process ends.

What can be seen is that the 3-dimensional modelling process known as solid works may have various modifications made to an existing 3D model simply through the use of extensions which are in fact the modifications that the creator of the 3D model wishes to impart to the final 3-dimensional transformation of the 2-dimensional artwork.

The ability to accommodate extensions incorporates the invention described in U.S. Pat. No. 7,688,318 which characterizes and reuses design data in a computer aided design model for automatically analyzing a computer aided design file to identify a set of elements, storing information corresponding to each element in a manner enabling query and retrieval of the information, presenting one element to a user interface upon retrieval of the information corresponding to the one element, selecting the presented element for inclusion in the model, and constructing the model by incorporating the presented element in the model. The stored information allows querying and searching for elements matching a search criteria in a manner free of opening the design file.

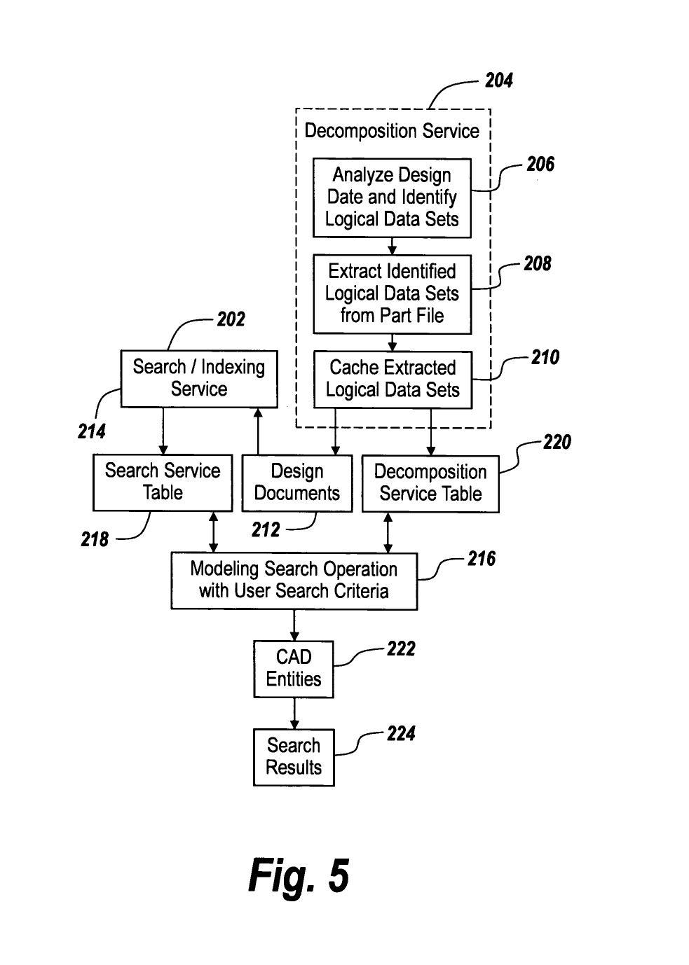

As illustrated in FIG. 5, the 3-dimensional modelling tool described in this patent incorporates a decomposition service 204 which starts with the analyzing a design date and identifying logical data sets as illustrated at 206, followed by extracting identified logical data sets from a part file as illustrated at 208, followed by forming a cache of extracted logical data sets as illustrated at 210. This decomposition service is then ported to design document 212 which is coupled to a search and indexing service 202 that in turn returns a search service table 214 as illustrated. Modelling and search operation with user search criteria illustrated at 216, with inputs being search service table 218 and the decomposition service table 220, thus to produce CAD entities 222 forming the search results 224.

FIGS. 4 and 5 thus show a 3-dimensional modelling system which can accommodate inputs from feature extraction 14 of FIG. 2 to provide extensions and thereby create or modify a 3D model in order to be able to create what the artist wishes when transforming the 2-dimensional artwork into the 3D rendition.

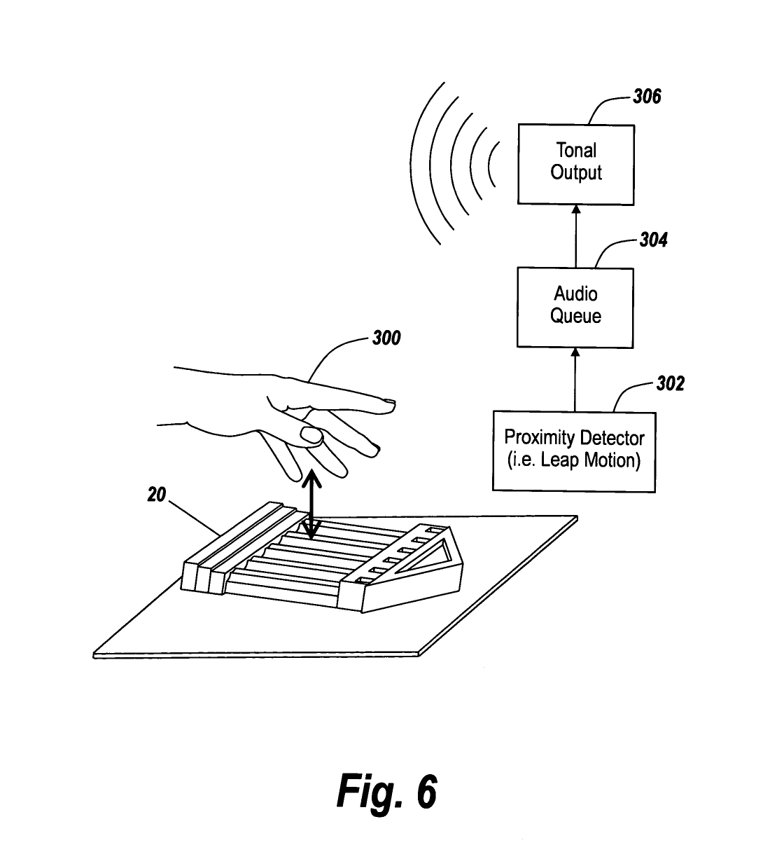

Referring now to FIG. 6, the “3D picture” 20 in the form of solid works is presented to an individual whose hand 300 is utilized to sense the features of the 3D solid work. Rather than actually touching the solid work, the proximity of the individual's hand may be determined by a proximity detector 302, with an audio queue 304 generated by the proximity detector such that a tonal output 306 is generated. Thus, by listening to the audio queues, an individual can gauge how close his finger or hand is to the 3 dimensional solid work. This provides an audio feedback to the individual seeking to experience the 3D artwork as the individual moves his or her hand over the 3D artwork, and creates a total new dimension to experiencing 2D art.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A system for providing a blind person with the experience of seeing a 2 dimensional piece of art comprising:
a scanner for scanning a 2 dimensional artwork,
a feature extraction module coupled to said scanner for determining features of said 2 dimensional artwork and,
a 3 dimensional printer coupled to said feature extraction module for generating a 3 dimensional solid based on an extracted feature such that said 2 dimensional artwork is 3D printed in a three dimensional rendering in the form of a solid 3 dimensional piece of artwork, the contours and textures of which can be sensed by a blind person.

2. The system of claim 1, wherein said extracted features include contours that exist in said 2 dimensional artwork.

3. The system of claim 2, wherein said contours include delineations between dark and light areas in said 2 dimensional artwork.

4. The system of claim 1, wherein said extracted features include the composition of the media used in creating said 2 dimensional artwork and wherein said 3 dimensional printer prints a corresponding portion of said 2 dimensional artwork with a texture corresponding to the composition of the media utilized in said 2 dimensional artwork.

5. The system of claim 1, and further including a proximity sensor for sensing the proximity of a hand or part thereof of an individual to a feature on said 3 dimensional artwork.

6. The system of claim 5, and further including an audio feedback system for providing audio corresponding to the proximity of said hand to a feature on said 3 dimensional artwork.

7. A method for providing an enhanced experience for an individual seeking to view artwork comprising the steps of:
scanning an original artwork,
extracting a predetermined feature of the original artwork and,
providing a 3 dimensional printing of the original artwork based on the sensed feature such that the 3 dimensional printed solid work provides an enhanced appreciation of the original artwork.

8. The method of claim 7, wherein the extracted feature includes contours within the original artwork, and wherein the dimensional printing provides the corresponding 3 dimensional solid work based on the extracted contours.
